(19) United States
(12) Patent Application Publication
(10) Pub. No.: US 2025/0342486 A1
(43) Pub. Date: Nov. 6, 2025

(54) STATE TRANSITION MANAGEMENT APPARATUS, STATE TRANSITION MANAGEMENT METHOD, AND COMPUTER READABLE MEDIUM

(71) Applicant: Mitsubishi Electric Corporation, Tokyo (JP)

(72) Inventors: Nako TSUDA, Tokyo (JP); Mitsuhiro MATSUMOTO, Tokyo (JP)

(73) Assignee: Mitsubishi Electric Corporation, Tokyo (JP)

(21) Appl. No.: 19/265,514

(22) Filed: Jul. 10, 2025

Related U.S. Application Data
(63) Continuation of application No. PCT/JP2023/005999, filed on Feb. 20, 2023.

(51) Int. Cl. G06Q 30/018

(52) U.S. Cl. CPC G06Q 30/018

(57) ABSTRACT

When a received state transition rule is a rule for registration, a rule registration unit (112) sets an initial version number for each of state transitions in the rule for registration, as an event, and registers the set rule for registration to a rule storage unit. When a received state transition rule is a rule for updating, the rule registration unit (112) selects from the rule storage unit, a state transition rule whose type is the same as that of the rule for updating, adds to the selected state transition rule, each of state transitions that are not present in the selected state transition rule, among the state transitions in the rule for updating, and sets for each of the state transitions in the selected state transition rule, the version number next to the latest version number in the selected state transition rule, as an event.

### CROSS REFERENCE TO RELATED APPLICATION

This application is a Continuation of PCT International Application No. PCT/JP2023/005999, filed on Feb. 20, 2023, which is hereby expressly incorporated by reference into the present application.

### TECHNICAL FIELD

The present disclosure relates to state transition rules and the management of states.

### BACKGROUND ART

In recent years, product traceability management has been demanded in product distribution.

States of products are registered in product traceability management. For example, a state such as “manufacturing”, “stored”, or “transporting” is registered.

It is possible to prevent an incorrect state from being registered by verifying whether or not a state transition complies with predefined rules at the time of state registration.

A large number of business operators are involved in product distribution. Therefore, it is necessary to consider changing the rule version of the state transition either at the beginning of the state transition or while the state transition is in progress.

Patent Literature 1 discloses a method for workflow control.

### CITATION LIST

### Patent Literature

Patent Literature 1: JP 2008-310710 A

### SUMMARY OF INVENTION

### Technical Problem

The method of Patent Literature 1 is a method for workflow control, not a method for managing state transitions in product distribution. Further, in the method of Patent Literature 1, version management is not performed. Even if the method of Patent Literature 1 is applied to state transitions, it is not possible to add or delete states depending on a version. Furthermore, it is not possible to change the version while a state transition is in progress.

State transitions associated with objects are managed in product distribution. Although it is possible to start over from the beginning in the middle of a workflow, it is difficult to start over from the beginning in the middle of product distribution. Therefore, a problem in product distribution is that it is not possible to make a version change while a state transition is in progress.

The purpose of this disclosure is to enable a version change while a state transition is in progress.

### Solution to Problem

A state transition management apparatus according to the present disclosure includes:
a reception unit to receive a state transition rule that indicates a series of state transitions; and
a rule registration unit, when the received state transition rule is a rule for registration, to set an initial version number for each of one or more state transitions in the series of state transitions, as an event, and to register the set rule for registration to a rule storage unit.

### Advantageous Effects of Invention

According to the present disclosure, it is possible to set a version number for each state transition in a state transition rule, as an event. Then, for each state to be registered while a state transition is in progress, a user can specify the version number of a state transition that the user wants to use and can change the version of the state transition, by using such a state transition rule. In other words, it is possible to make a version change while a state transition is in progress.

### BRIEF DESCRIPTION OF DRAWINGS

FIG. 1 is a configuration diagram of a state transition management apparatus 100 in Embodiment 1.

FIG. 2 is a configuration diagram of a state transition management system 200 in Embodiment 1.

FIG. 3 is a flowchart of rule registration in Embodiment 1.

FIG. 4 is a diagram illustrating a rule for registration 201 in Embodiment 1.

FIG. 5 is a flowchart of step S110 in Embodiment 1.

FIG. 6 is a flowchart of step S110 in Embodiment 1.

FIG. 7 is a diagram illustrating a specific example of step S110 in Embodiment 1.

FIG. 8 is a flowchart of state registration in Embodiment 1.

FIG. 9 is a flowchart of step S130 in Embodiment 1.

FIG. 10 is a diagram illustrating a specific example of step S130 in Embodiment 1.

FIG. 11 is a diagram illustrating a specific example of step S124 in Embodiment 1.

FIG. 12 is a flowchart of step S140 in Embodiment 1.

FIG. 13 is a diagram illustrating a specific example of step S140 in Embodiment 1.

FIG. 14 is a diagram illustrating a specific example of step S127 in Embodiment 1.

FIG. 15 is a configuration diagram of the state transition management system 200 in Embodiment 2.

FIG. 16 is a flowchart of state registration A in Embodiment 2.

FIG. 17 is a flowchart of state registration B in Embodiment 2.

FIG. 18 is a hardware configuration diagram of the state transition management apparatus 100 in the embodiments.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in the diagrams mainly indicate flows of data or flows of processes.

### Embodiment 1

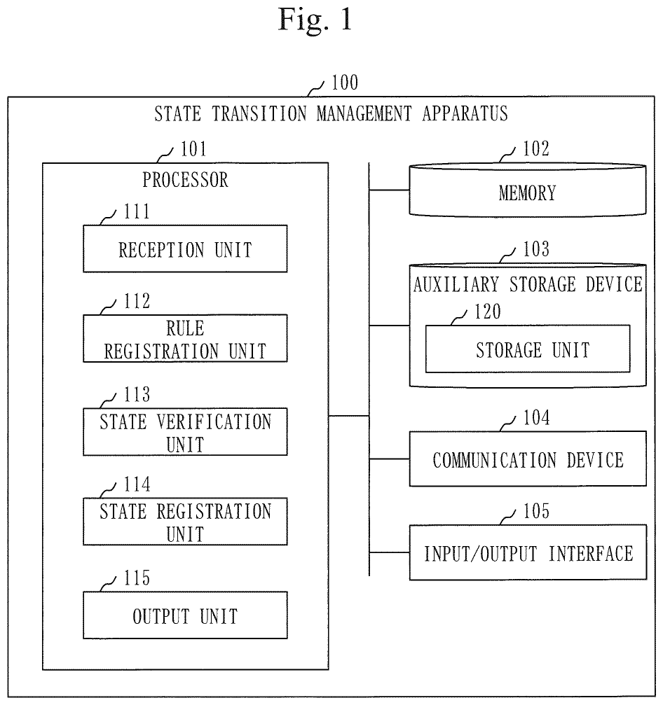

A state transition management apparatus 100 will be described based on FIGS. 1 to 14.

### ***Description of Configuration***

A configuration of the state transition management apparatus 100 will be described based on FIG. 1.

The state transition management apparatus 100 is a computer that includes pieces of hardware such as a processor 101, a memory 102, an auxiliary storage device 103, a communication device 104, and an input/output interface 105. These pieces of hardware are connected with one another through signal lines.

The processor 101 is an IC that performs arithmetic processing and controls other pieces of hardware. The processor 101 is, for example, a CPU.

IC is abbreviation for Integrated Circuit.

CPU is abbreviation for Central Processing Unit.

The memory 102 is either a volatile or non-volatile storage device. The memory 102 is also called as a main storage device or a main memory. The memory 102 is, for example, an RAM. Data stored in the memory 102 is saved in the auxiliary storage device 103 as necessary.

RAM is an abbreviation for Random Access Memory.

The auxiliary storage device 103 is a non-volatile storage device. The auxiliary storage device 103 is, for example, an ROM, an HDD, a flash memory, or a combination thereof. Data stored in the auxiliary storage device 103 is loaded into the memory 102 as necessary.

ROM is an abbreviation for Read Only Memory.

HDD is an abbreviation for Hard Disk Drive.

The communication device 104 is a receiver and a transmitter. The communication device 104 is, for example, a communication chip or an NIC. Communication of the state transition management apparatus 100 is performed using the communication device 104.

NIC is an abbreviation for Network Interface Card.

The input/output interface 105 is a port to which an input device and an output device are connected. The input/output interface 105 is, for example, a USB terminal, the input device is, for example, a keyboard or a mouse, and the output device is, for example, a display. Input and output of the state transition management apparatus 100 is performed using the input/output interface 105.

USB is an abbreviation for Universal Serial Bus.

The state transition management apparatus 100 includes elements such as a reception unit 111, a rule registration unit 112, a state verification unit 113, a state registration unit 114, and an output unit 115. These elements are implemented by software.

The auxiliary storage device 103 stores a state transition management program that causes a computer to function as the reception unit 111, the rule registration unit 112, the state verification unit 113, the state registration unit 114, and the output unit 115. The state transition management program is loaded into the memory 102 and executed by the processor 101.

The auxiliary storage device 103 further stores an OS. At least a part of the OS is loaded into the memory 102 and executed by the processor 101.

While executing the OS, the processor 101 also executes the state transition management program.

OS is an abbreviation for Operating System.

Input/output data of the state transition management program is stored in a storage unit 120.

The auxiliary storage device 103 functions as the storage unit 120. However, storage devices such as the memory 102, a register in the processor 101, and a cache memory in the processor 101 may function as the storage unit 120 in place of the auxiliary storage device 103, or together with the auxiliary storage device 103.

The state transition management program can be recorded (stored) in a computer-readable format on a non-volatile recording medium such as an optical disc or a flash memory.

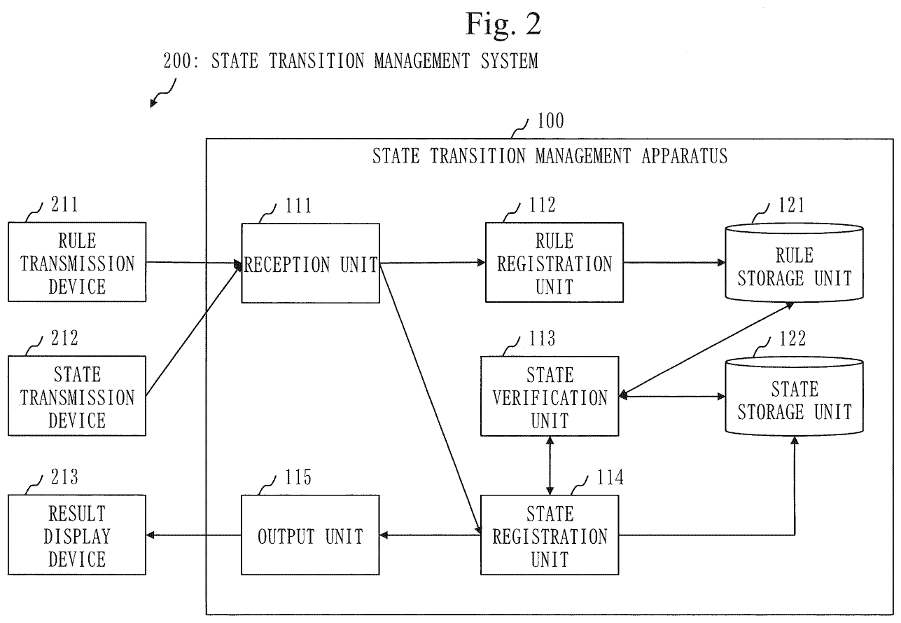

A configuration of the state transition management system 200 will be described based on FIG. 2.

The state transition management system 200 includes the state transition management apparatus 100, a rule transmission device 211, a state transmission device 212, and a result display device 213.

The rule transmission device 211, the state transmission device 212, and the result display device 213 are computers used by a user. A single computer may function as the rule transmission device 211, the state transmission device 212, and the result display device 213.

A rule storage unit 121 and a state storage unit 122 are a part of the storage unit 120.

### ***Description of Operation***

An operation procedure of the state transition management apparatus 100 is equivalent to a state transition management method. Further, the operation procedure of the state transition management apparatus 100 is equivalent to a processing procedure of the state transition management program.

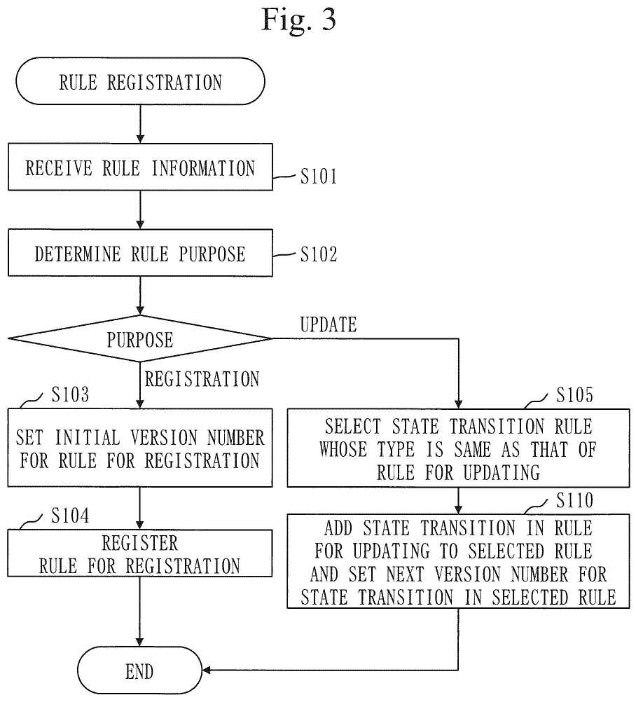

Rule registration will be described based on FIG. 3. The rule registration is a part of the state transition management method.

In step S101, the reception unit 111 receives rule information.

The rule information indicates a rule type and a state transition rule.

The rule type is a type of the state transition rule.

The state transition rule indicates a series of state transitions from the head state to the end state.

The series of state transitions includes one or more state transitions.

A state transition is a transition between states of two states. The state transition occurs in response to a specific event.

The rule information is received as follows.

The user inputs the rule information into the rule transmission device 211.

The rule transmission device 211 transmits the input rule information to the state transition management apparatus 100.

The reception unit 111 receives the transmitted rule information.

In step S102, the rule registration unit 112 receives the rule information from the reception unit 111 and determines a rule purpose. The rule purpose refers to the purpose of the rule information.

The rule purpose has types such as rule registration and rule update.

The rule information is registered in the rule storage unit 121 during the rule registration.

The rule information is used to update a registered rule during the rule update. The registered rule is a state transition rule registered in the rule storage unit 121.

The rule purpose is determined as follows.

The user can specify the rule purpose. The specified rule purpose is indicated in the rule information. When the rule purpose is indicated in the rule information, the rule registration unit 112 refers to the rule information to determine the rule purpose.

The rule registration unit 112 searches the rule storage unit 121 to find the registered rule whose type is the same as the rule type in the rule information. When it is not found, the rule registration unit 112 determines that the rule purpose is the rule registration. When it is found, the rule registration unit 112 determines that the rule purpose is the rule update.

When the rule purpose is the rule registration, the process proceeds to step S103. In this case, the state transition rule in the rule information is referred to as a rule for registration.

When the rule purpose is the rule update, the process proceeds to step S105. In this case, the state transition rule in the rule information is referred to as a rule for updating.

In step S103, the rule registration unit 112 sets an initial version number for each of one or more state transitions in the rule for registration, as an event.

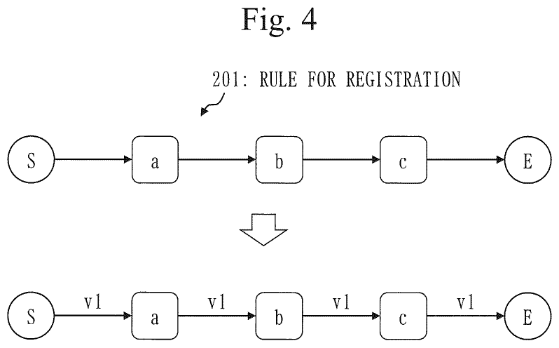

A specific example of step S103 will be described based on FIG. 4.

A rule for registration 201 is an example of the rule for registration.

“S” represents the beginning of a series of state transitions. “E” represents the end of the series of state transitions.

In the rule for registration 201, the head state is a state a, and the end state is a state c.

The series of state transitions of the rule for registration 201 includes a state transition from the state a to a state b, and a state transition from the state b to the state c.

The rule registration unit 112 sets a version number v1 for each of the state transitions in the series of state transitions. “v1” is the initial version number.

Returning to FIG. 3, the description will be continued from step S104.

In step S104, the rule for registration 201 registers the rule for registration for which the initial version number is set in the rule storage unit 121 together with the rule type in the rule information.

After step S104, the process ends.

In the rule storage unit 121, the format of the registered rule may be of any format, as long as it is a format that specifies a rule type, a version number, one or more states, and a transition between states.

In step S105, the rule registration unit 112 selects from the rule storage unit 121, the registered rule whose type is the same as the rule type in the rule information.

In step S110, the rule registration unit 112 adds to the selected registered rule, each of state transitions that are not present in the registered rule selected from one or more state transitions of the rule for updating.

Then, the rule registration unit 112 sets a next version number for each of the corresponding transitions in the selected registered rule, as an event.

The corresponding transitions are state transitions that correspond to state transitions in the rule for updating.

The next version number refers to the version number next to the latest version number in the registered rule.

After step S110, the process ends.

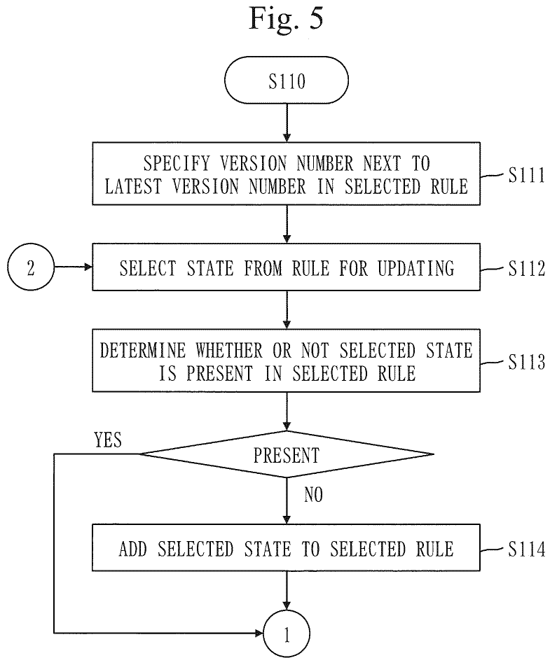

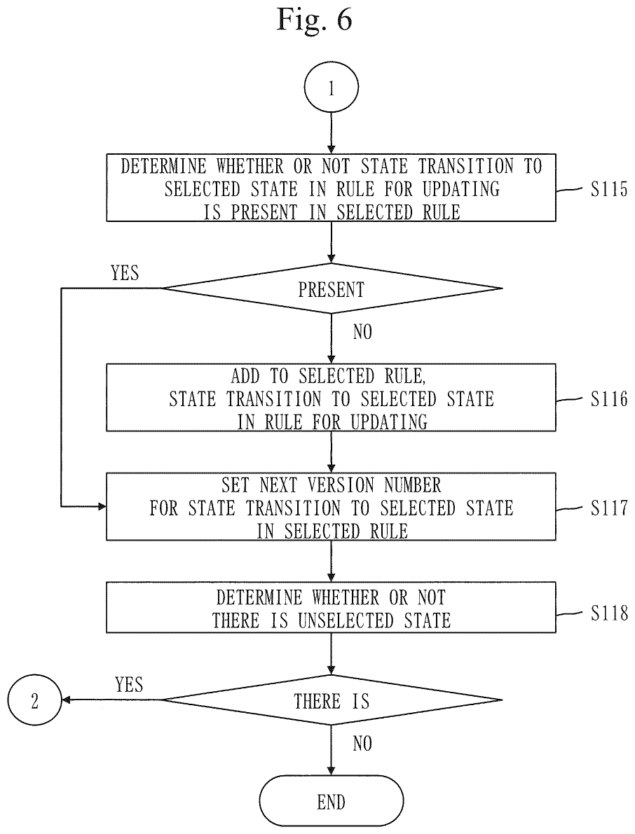

The details of step S110 will be described based on FIGS. 5 and 6.

The registered rule selected in step S105 is referred to as a selected rule.

In step S111, the rule registration unit 112 refers to the selected rule and specifies the latest version number in the selected rule.

Then, the rule registration unit 112 specifies the next version number based on the latest version number.

For example, the rule registration unit 112 specifies a number obtained by adding 1 to the latest version number, as the next version number.

In step S112, the rule registration unit 112 selects one unselected state in sequence from the head state in the rule for updating. The selected state is referred to as a selected state.

In step S113, the rule registration unit 112 determines whether or not the selected state is present in the selected rule.

When the selected state is present in the selected rule, the process proceeds to step S115.

When the selected state is not present in the selected rule, the process proceeds to step S114.

In step S114, the rule registration unit 112 adds the selected state to the selected rule.

When the selected state is the head state, the rule registration unit 112 adds the selected state to the selected rule as the head state.

When the selected state is the second state or later, the rule registration unit 112 adds the selected state to the selected rule as the next state of the previous state.

When the selected state is the end state, the rule registration unit 112 adds the selected state to the selected rule as the end state.

In step S115, the rule registration unit 112 refers to the rule for updating and specifies a state transition to the selected state. The specified state transition is referred to as a subject transition.

Then, the rule registration unit 112 refers to the selected rules and determines whether or not the subject transition is present in the selected rule.

When the subject transition is present in the selected rule, the process proceeds to step S117.

When the subject transition is not present in the selected rules, the process proceeds to step S116.

In step S116, the rule registration unit 112 adds the subject transition to the selected rule.

In step S117, the rule registration unit 112 sets the next version number for the subject transition in the selected rule, as an event.

In step S118, the rule registration unit 112 determines whether or not there is an unselected state in the rule for updating.

When there is the unselected state, the process proceeds to step S112.

When there is no unselected state, the process ends.

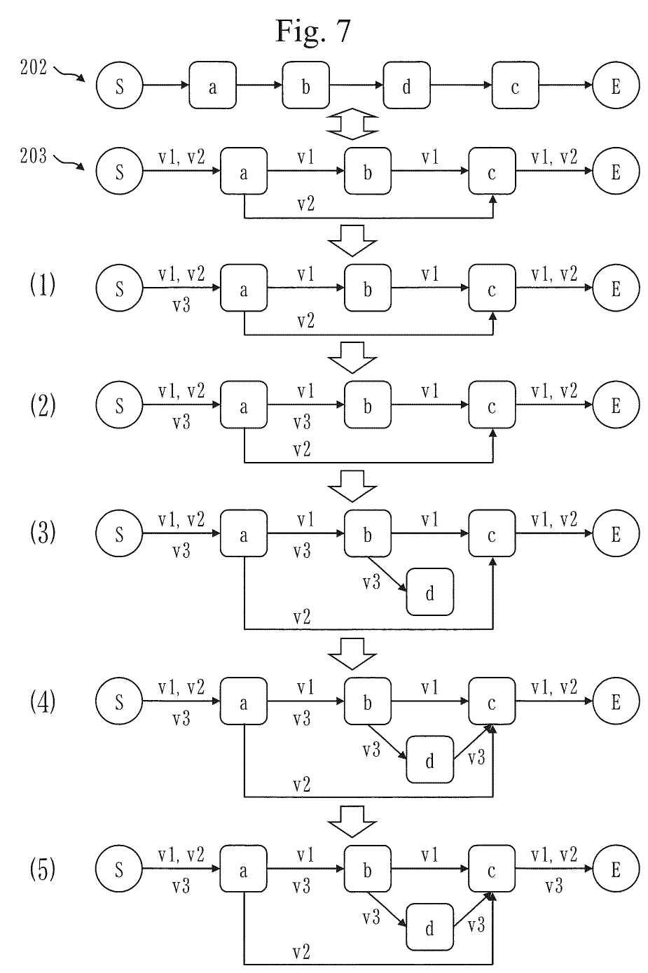

A specific example of step S110 will be described based on FIG. 7.

A rule for updating 202 is an example of the rule for updating. A registered rule 203 is an example of the registered rule whose type is the same as that of the rule for updating 202.

The latest version number in the registered rule 203 is v2. The version number next to the latest version number v2 is v3.

(1) A head state a in the rule for updating 202 is present in the registered rule 203. The rule registration unit 112 sets the next version number v3 for the state transition from the start to the state a in the registered rule 203.

(2) A second state b in the rule for updating 202 is present in the registered rule 203. The state transition from the state a to the state b in the rule for updating 202 is present in the registered rule 203. The rule registration unit 112 sets the next version number v3 for the state transition from the state a to the state b in the registered rule 203.

(3) A third state d in the rule for updating 202 is not present in the registered rule 203. The rule registration unit 112 adds the state d to the registered rule 203 and adds the state transition from the state b to the state d to the registered rule 203. Then, the rule registration unit 112 sets the next version number v3 for the state transition from the state b to the state d in the registered rule 203.

(4) An end state c in the rule for updating 202 is present in the registered rule 203. The state transition from the state d to the state c in the rule for updating 202 is not present in the registered rule 203. The rule registration unit 112 adds the state transition from the state d to the state c to the registered rule 203. Then, the rule registration unit 112 sets the next version number v3 for the state transition from the state d to the state c in the registered rule 203.

(5) The rule registration unit 112 sets the next version number v3 for the state transition from the state c to completion in the registered rule 203.

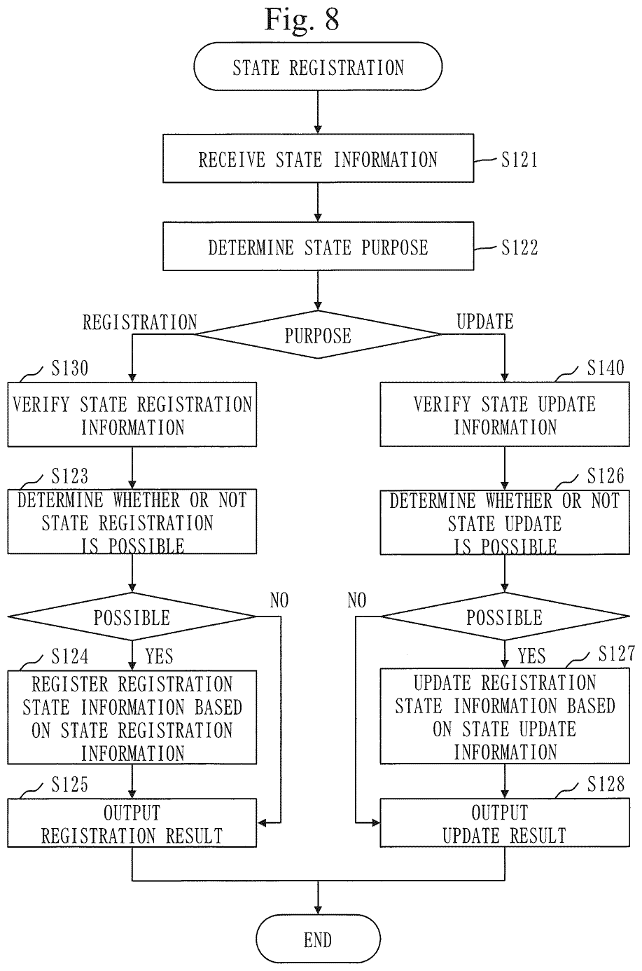

State registration will be described based on FIG. 8. The state registration is a part of the state transition management method.

In step S121, the reception unit 111 receives state information.

The state information indicates a new state.

The state information is received as follows.

The user inputs the state information into the state transmission device 212.

The state transmission device 212 transmits the input state information to the state transition management apparatus 100.

The reception unit 111 receives the transmitted state information.

In step S122, the state registration unit 114 receives the state information from the reception unit 111 and determines a state purpose. The state purpose refers to the purpose of the state information.

The state purpose has types such as state registration and state update.

The state information for the state registration is referred to as state registration information. The state registration information is registered in the state storage unit 122.

The state information for the state update is referred to as state update information. The state update information is used to update registration state information. The registration state information is the state information registered in the state storage unit 122.

The state purpose is determined as follows.

The user can specify the state purpose. The specified state purpose is indicated in the state information. When the state purpose is indicated in the state information, the state registration unit 114 refers to the state information to determine the state purpose.

When the state purpose is the state registration, the user can specify the rule type. The specified rule type is indicated in the state information. When the rule type is indicated in the state information, the state registration unit 114 determines that the state purpose is the state registration.

When the state purpose is the state update, the user can specify a registration state identifier. The specified registration state identifier is indicated in the state information. When the registration state identifier is indicated in the state information, the state registration unit 114 determines that the state purpose is the state update. When the registration state identifier is not indicated in the state information, the state registration unit 114 can determine that the state purpose is the state registration.

When the state purpose is the state registration, the process proceeds to step S130.

When the state purpose is the state update, the process proceeds to step S140.

In step S130, the state verification unit 113 receives the state registration information from the state registration unit 114, and verifies the state registration information.

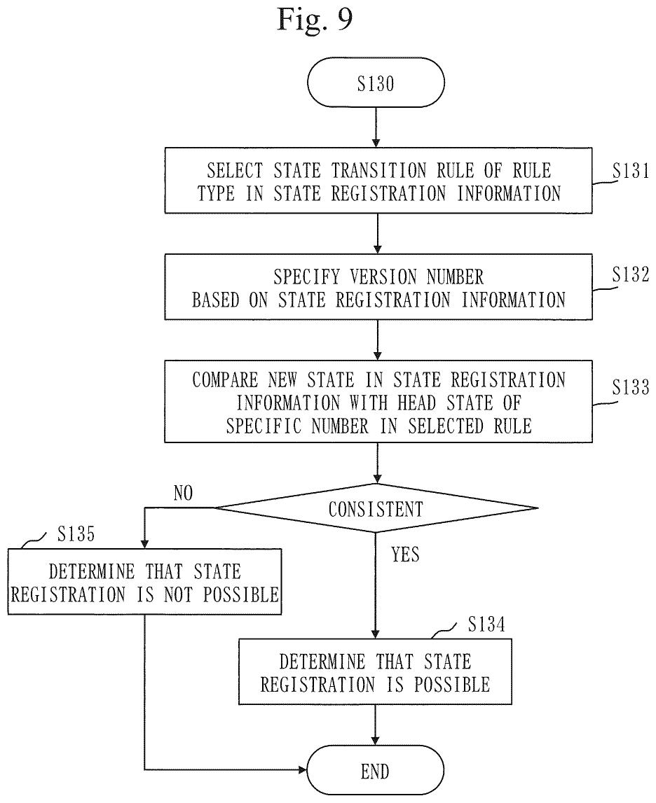

The details of step S130 will be described based on FIG. 9.

In step S131, the state verification unit 113 selects from the rule storage unit 121, the registered rule whose type is the same as the rule type in the state registration information. The selected registered rule is referred to as a selected rule.

In step S132, the state verification unit 113 specifies the version number based on the state registration information. The specified version number is referred to as a specific number.

The specific number is specified as follows.

The user can specify the version number. The specified version number is indicated in the state registration information. When the version number is indicated in the state registration information, the state verification unit 113 specifies the version number indicated in the state registration information as the specific number. When the version number is not indicated in the state registration information, the state verification unit 113 specifies the latest version number in the selected rule as the specific number.

In step S133, the state verification unit 113 selects from the selected rule, one or more state transitions for which the specific number is set.

Next, the state verification unit 113 selects the head state in the selected one or more state transitions.

Then, the state verification unit 113 compares the new state in the state registration information with the selected head state.

When the new state in the state registration information is consistent with the selected head state, the process proceeds to step S134.

When the new state in the state registration information is not consistent with the selected head state, the process proceeds to step S135.

In step S134, the state verification unit 113 determines that the state registration is possible.

Then, the state verification unit 113 outputs a verification result that indicates the specific number and the information that the state registration is possible.

In step S135, the state verification unit 113 determines that the state registration is not possible.

Then, the state verification unit 113 outputs a verification result that indicates that the state registration is not possible.

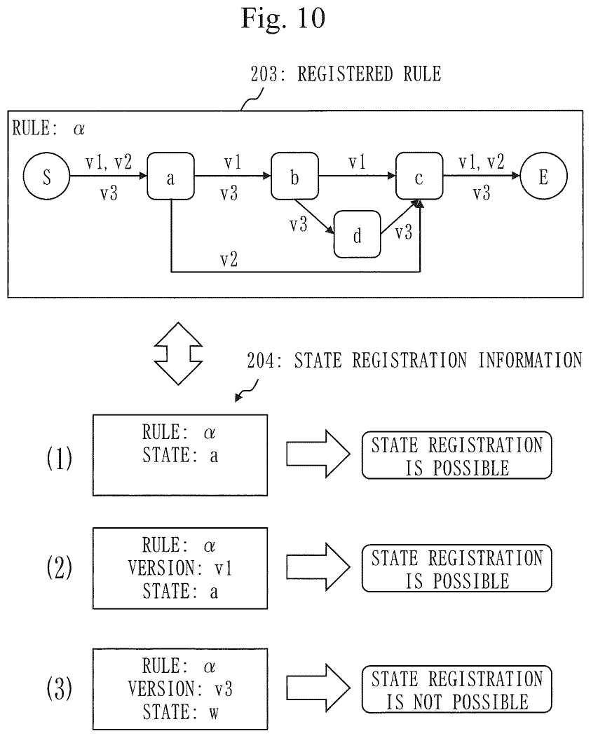

A specific example of step S130 will be described based on FIG. 10.

State registration information 204 is an example of the state registration information.

The registered rule 203 is the registered rule whose rule type is the same as a rule type α in the state registration information 204.

(1) The version number is not indicated in the state registration information 204. The latest version number in the registered rule 203 is v3. In the registered rule 203, the head state of the version number v3 is the state a. The head state a of the version number v3 is consistent with the new state a in the state registration information 204. In this case, the state verification unit 113 determines that the state registration is possible.

(2) The version number in the state registration information 204 is v1. In the registered rule 203, the head state of the version number v1 is the state a. The head state a of the version number v1 is consistent with the new state a in the state registration information 204. In this case, the state verification unit 113 determines that the state registration is possible.

(3) The version number in the state registration information 204 is v3. In the registered rule 203, the head state of the version number v3 is the state a. The head state a of the version number v3 is not consistent with a new state w in the state registration information 204. In this case, the state verification unit 113 determines that the state registration is not possible.

Returning to FIG. 8, the description will be continued.

After step S130, the process proceeds to step S123.

In step S123, the state registration unit 114 receives the verification result from the state verification unit 113, and refers to the verification result to determine whether or not the state registration is possible.

When the state registration is possible, the process proceeds on to step S124.

When the state registration is not possible, the process proceeds to step S125.

In step S124, the state registration unit 114 generates a new registration state identifier. The new registration state identifier is a registration state identifier that is not present in the state storage unit 122.

Then, the state registration unit 114 generates new registration state information based on the state registration information and registers the new registration state information in the state storage unit 122.

The new registration state information indicates the new registration state identifier, the new state in the state registration information, the rule type in the state registration information, and the version number in the verification result.

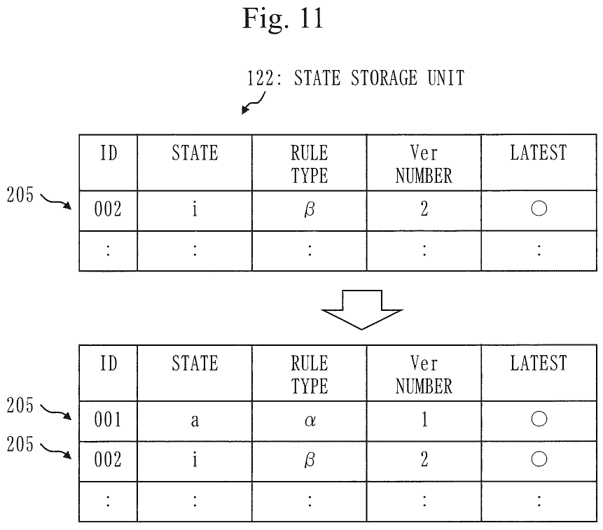

A specific example of step S124 will be described based on FIG. 11.

Registration state information 205 has an ID column, a state column, a rule type column, a Ver number column, and a latest column.

The ID column indicates a registration state identifier.

The state column indicates a state.

The rule type column indicates a rule type.

The Ver number column indicates a version number.

The latest column indicates whether the state in the state column is the latest or not.

The state registration unit 114 generates the registration state information 205 for ID 001, and registers the registration state information 205 for ID 001 in the state storage unit 122.

Returning to FIG. 8, step S125 will be described.

In step S125, the output unit 115 receives a registration result from the state registration unit 114, and outputs the registration result.

When it is determined in step S123 that the state registration is possible, the registration result indicates the information of registration completion and the registration state identifier.

When it is determined in step S123 that the state registration is not possible, the registration result indicates the information of a registration error and the verification result.

Specifically, the output unit 115 transmits the registration result to the result display device 213. The result display device 213 receives the registration result and displays the registration result on a display. The user checks the displayed registration result.

After step S125, the process ends.

The description will be continued from step S140.

In step S140, the state verification unit 113 receives the state update information from the state registration unit 114, and verifies the state update information.

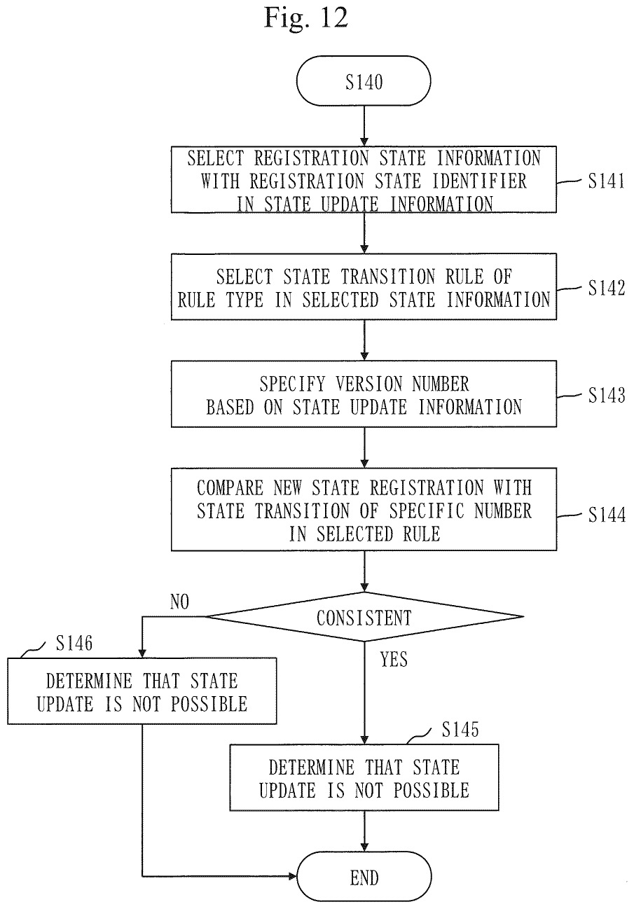

The details of step S140 will be described based on FIG. 12.

In step S141, the state verification unit 113 selects from the state storage unit 122, the registration state information whose registration state identifier is the same as the registration state identifier in the state update information. The state indicated in the state column of the selected registration state information is the latest state. The selected registration state information is referred to as selected state information.

When there is no registration state information whose registration state identifier is the same as the registration state identifier in the state update information in the state storage unit 122, the state verification unit 113 outputs the verification result that indicates that the state registration is not possible because the corresponding registration state information is not present. Then, the process ends.

In step S142, the state verification unit 113 selects from the rule storage unit 121, the registered rule whose type is the same as the rule type in the selected state information. The selected registered rule is referred to as a selected rule.

In step S143, the state verification unit 113 specifies the version number based on the state update information. The specified version number is referred to as a specific number.

The specific number is specified as follows.

The user can specify the version number. The specified version number is indicated in the state update information. When the version number is indicated in the state update information, the state verification unit 113 specifies the version number indicated in the state update information as the specific number. When the version number is not indicated in the state update information, the state verification unit 113 specifies the version number in the selected state information as the specific number.

In step S144, the state transition from the latest state in the selected state information to the new state in the state update information is referred to as a new state transition.

First, the state verification unit 113 selects from the selected rule, the state transition for which the specific number is set.

Then, the state verification unit 113 compares the new state transition with each of the selected state transitions.

When the new state transition is consistent with any of the selected state transitions, the process proceeds to step S145.

When the new state transition is not consistent with any of the selected state transitions, the process proceeds to step S146.

In step S145, the state verification unit 113 determines that the state registration is possible.

Then, the state verification unit 113 outputs the verification result that indicates the information that the state registration is possible, and indicates the rule type and specific number in the selected state information.

In step S146, the state verification unit 113 determines that the state registration is not possible.

Then, the state verification unit 113 outputs the verification result that indicates that the state registration is not possible.

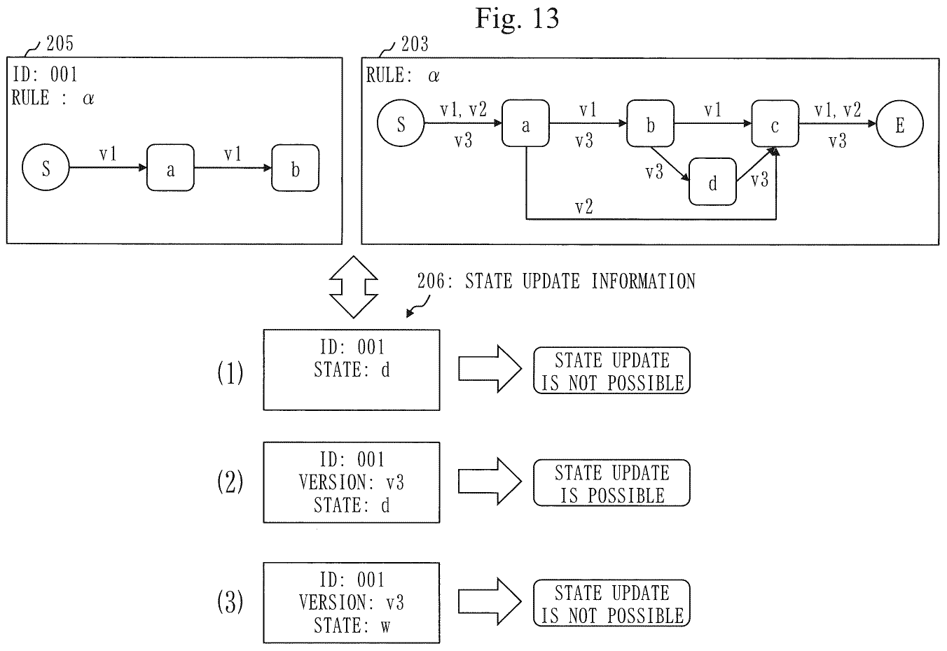

A specific example of step S140 will be described based on FIG. 13.

State update information 206 is an example of the state update information.

The registration state information 205 is the registration state information whose registration state identifier is the same as the registration state identifier 001 in the state update information 206.

The registered rule 203 is the registered rule whose rule type is the same as the rule type α in the registration state information 205.

(1) The version number is not indicated in the state update information 206. The version number in the selected state information is v1. The state transition from the latest state b in the registration state information 205 to the new state d in the state update information 206 is the new state transition. The new state transition (b→d) is not consistent with any of the state transitions of the version number v1 in the registered rule 203. In this case, the state verification unit 113 determines that the state registration is not possible.

(2) The version number in the state update information 206 is v3. The state transition from the latest state b in the registration state information 205 to the new state d in the state update information 206 is the new state transition. The new state transition (b→d) is consistent with the state transition (b→d) of the version number v3 in the registered rule 203. In this case, the state verification unit 113 determines that the state registration is possible.

(3) The version number in the state update information 206 is v3. The state transition from the latest state b in the registration state information 205 to the new state w in the state update information 206 is the new state transition. The new state transition (b→w) is not consistent with any of the state transitions of the version number v3 in the registered rule 203. In this case, the state verification unit 113 determines that the state registration is not possible.

Returning to FIG. 8, the description will be continued.

After step S140, the process proceeds to step S126.

In step S126, the state registration unit 114 receives the verification result from the state verification unit 113, and refers to the verification result to determine whether or not the state update is possible.

When the state update is possible, the process proceeds to step S127.

When the state update is not possible, the process proceeds to step S128.

In step S127, the state registration unit 114 updates the registration state information whose registration state identifier is the same as the registration state identifier in the state update information, based on the state update information.

Specifically, the state registration unit 114 generates new registration state information based on the state update information, and adds the new registration state information to the state storage unit 122.

The new registration state information indicates the registration state identifier in the state update information, the new state in the state update information, the rule type in the verification result, and the version number in the verification result.

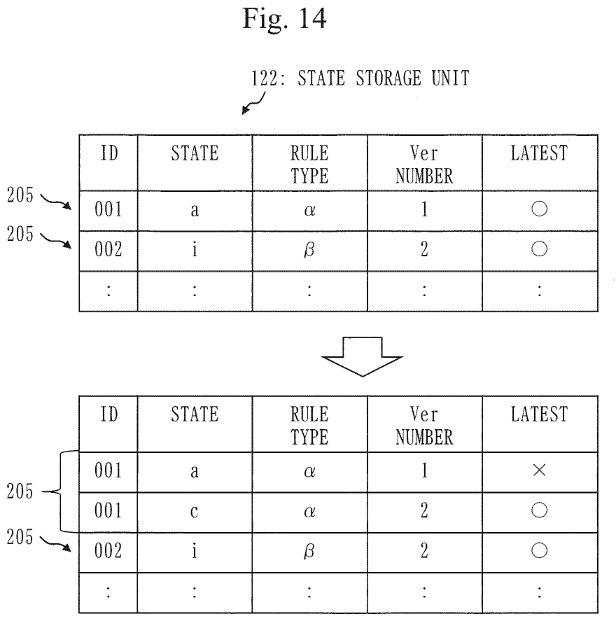

A specific example of step S127 will be described based on FIG. 14.

The state registration unit 114 generates the new registration state information 205 for ID 001, and adds the new registration state information 205 for ID 001 to the state storage unit 122.

The state registration unit 114 modifies the information in the latest column of the previous registration state information 205 for ID 001 to the information that indicates that the state in the state column is not the latest state.

Thereby, the registration state information 205 for ID 001 is updated.

The registration state information 205 for ID 001 indicates the previous state a and the latest state c. In both the previous state a and the latest state c, the version numbers of the state transitions are different.

The version number of the state transition may be the same for all states, or could be different for each state. In other words, the user can specify a different version number for each state registration.

Returning to FIG. 8, step S128 will be described.

In step S128, the output unit 115 receives an update result from the state registration unit 114 and outputs the update result.

When it is determined in step S126 that the state update is possible, the update result indicates the information of update completion and the registration state identifier.

When it is determined in step S126 that the state update is not possible, the update result indicates the information of an update error and the verification result.

Specifically, the output unit 115 transmits the update result to the result display device 213. The result display device 213 receives the update result and displays the update result on the display. The user checks the displayed update result.

After step S128, the process ends.

### ***Effects of Embodiment 1***

The main features of Embodiment 1 are the rule registration unit 112 and the state verification unit 113. Particularly, it is characterized by registering a state transition rule for which a version of a state transition is set as an event (action). In addition, it is also characterized by the fact that when a new state is input, the new state is registered after checking that a new state transition complies with the rule.

Conventionally, it has not been possible to add or delete states depending on the version of the state transition.

In Embodiment 1, the input state transition rule is added to the registered state transition rule as a rule of the new version. In other words, Embodiment 1 has the effect of being able to manage the version of the state transition where the state is added or deleted.

If the state transition where the state is added or deleted is managed as a separate state transition rule, it is not possible to change the version of the state transition while the state transition is in progress.

In Embodiment 1, a state transition rule is refereed to, for which a version is set as an event (action). Therefore, Embodiment 1 has the effect that it is possible to check, even while the state transition is in progress, that the input state complies with the rule, using the specified version of the state transition.

### ***Practical Examples of Embodiment***

The registered rule and the registration state information may be managed by a plurality of state transition management apparatuses 100 that communicate with each other via a network. For example, the registered rule and the registration state information may be managed using distributed ledger technology or blockchain technology.

### Embodiment 2

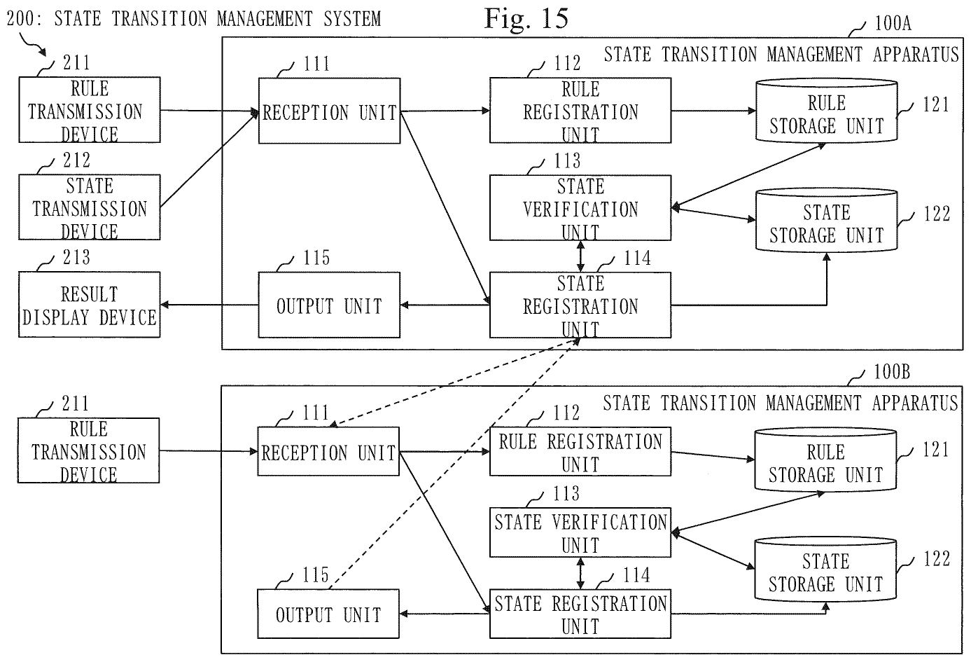

With respect to the form in which the plurality of state transition management apparatuses 100 are used, differences from Embodiment 1 will be mainly described based on FIGS. 15 through 17.

### ***Description of Configuration***

A configuration of the state transition management system 200 will be described based on FIG. 15.

The state transition management system 200 includes a plurality of state transition management apparatuses (100A, 100B).

The state transition management apparatus 100A is a private state transition management apparatus 100.

The state transition management apparatus 100B is a public state transition management apparatus 100.

Each of the state transition management apparatus 100A and the state transition management apparatus 100B may be two or more.

The state transition information managed by the state transition management apparatus 100A is only used by a specific user or a specific system.

The state transition information managed by the state transition management apparatus 100B is used by an unspecified number of users or another system.

### ***Description of Operation***

Rule registration will be described.

The user inputs the rule information of the rule for registration into each of the state transition management apparatus 100A and the state transition management apparatus 100B.

The user inputs the rule information of the rule for updating into either the state transition management apparatus 100A or the state transition management apparatus 100B.

The operation of the state transition management apparatus 100A into which the rule information is input is the same as the operation of the state transition management apparatus 100 in Embodiment 1. The state transition rule in the input rule information is managed by the state transition management apparatus 100A.

The operation of the state transition management apparatus 100B into which the rule information is input is the same as the operation of the state transition management apparatus 100 in Embodiment 1. The state transition rule in the input rule information is managed by the state transition management apparatus 100B.

The propriety of disclosure is assigned to each state in the state transition rule.

The propriety of disclosure indicates whether or not the state can be disclosed.

The rule for registration whose content has been confirmed as correct in advance. For example, all or some of the operators that use the state transition management system 200 confirm in advance that the rule for registration is the correct state transition rule.

State registration will be described.

The user inputs the state information into the state transition management apparatus 100A.

The state information indicates a new state.

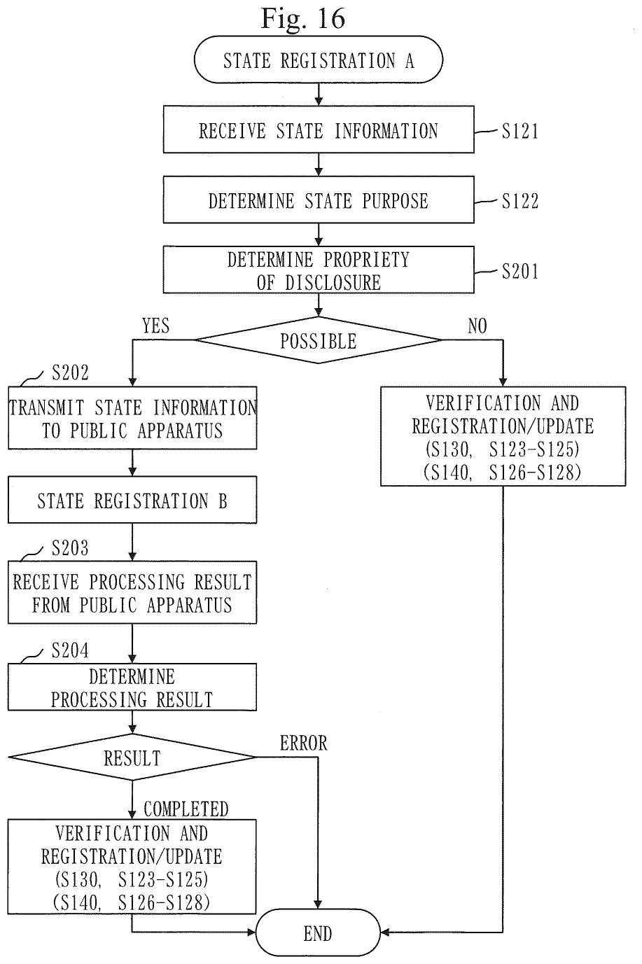

State registration A will be described based on FIG. 16. The state registration A is the state registration in the state transition management apparatus 100A.

In step S121, the reception unit 111 receives the state information.

In step S122, the state registration unit 114 determines the state purpose.

Steps S121 and S122 are as described in Embodiment 1.

After step S122, the process proceeds to step S201.

In step S201, the state registration unit 114 determines the propriety of disclosure of the new state.

The propriety of disclosure is determined as follows.

The user can specify the propriety of disclosure. The specified propriety of disclosure is indicated in the state information.

When the propriety of disclosure is indicated in the state information, the state registration unit 114 refers to the state information to determine the propriety of the state.

When the propriety of disclosure is not indicated in the state information, the state registration unit 114 transmits the state information and usage information to the state transition management apparatus 100B, and inquiries about the propriety of disclosure. The usage information indicates a state purpose.

In the state transition management apparatus 100B, the state registration unit 114 selects the state transition rule corresponding to the state information depending on the state purpose (same as in S131 or S142). The state registration unit 114 selects the state corresponding to the new state from the selected state transition rule and refers to the propriety of disclosure that is assigned to the selected state. Then, the state registration unit 114 responds to the state transition management apparatus 100A regarding the propriety of disclosure.

When the new state is in a non-disclosable state, the state transition management apparatus 100A executes verification and registration/update. Specifically, when the state purpose is the state registration, steps S130 and S123 through S125 are executed, and when the state purpose is the state update, steps S140 and S126 through S128 are executed. After that, the process ends.

When the new state is disclosable, the process proceeds to step S202.

In step S202, the state registration unit 114 transmits the state information and the usage information to the state transition management apparatus 100n.

After step S202, state registration B to be described below is executed on the state transition management apparatus 100B, and the process proceeds to step S203.

In step S203, the state registration unit 114 receives a processing result (registration result or update result) from the state transition management apparatus 100B.

When the state purpose is the state registration, the registration result is the processing result.

When the state purpose is the state update, the update result is the processing result.

The description of step S203 will be continued.

The output unit 115 outputs the processing result (same as in S125 or S128).

After step S203, the process proceeds to step S204.

In step S204, the state registration unit 114 determines the processing result.

When the processing result indicates registration completion or update completion, the state transition management apparatus 100A executes verification and registration/update. After that, the process ends.

When the processing result indicates a registration error or an update error, the process ends.

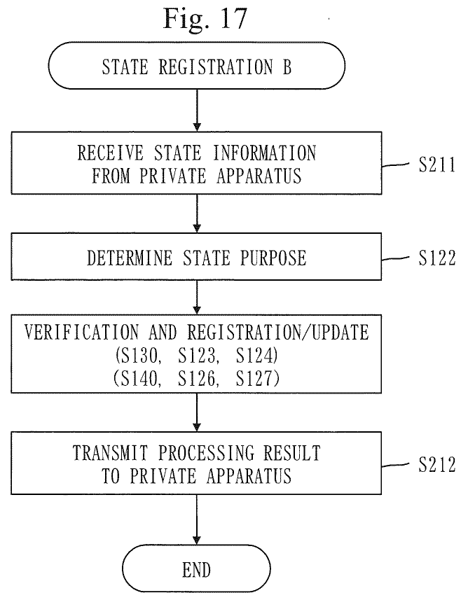

The state registration B will be described based on FIG. 17. The state registration B is the state registration in the state transition management apparatus 100B.

In step S211, the state registration unit 114 receives the state information and the usage information from the state transition management apparatus 100A.

After step S211, the process proceeds to step S122.

In step S122, the state registration unit 114 determines the state purpose.

Step S122 is as described in Embodiment 1.

After step S122, the state transition management apparatus 100B executes verification and registration/update. Specifically, when the state purpose is the state registration, steps S130, S123, and S124 are executed. When the state purpose is the state update, steps S140, S126, and S127 are executed.

After that, the process proceeds to step S212.

In step S212, the state registration unit 114 transmits the processing result (registration result or update result) to the state transition management apparatus 100A.

After step S212, the process ends.

### ***Effects of Embodiment 2***

Embodiment 2 utilizes the plurality of state transition management apparatuses 100.

By utilizing the plurality of state transition management apparatuses 100, for example, state transition management can be performed by each of a plurality of operators. Specifically, depending on the circumstances, it is possible to switch between state transitions managed solely by a specific operator and state transitions managed jointly by a large number of operators. Thereby, it is possible to manage state transitions that are shared while also managing state transitions that are not disclosed to other operators.

### ***Practical Examples of Embodiment 2***

The state transition management system 200 may have a function that when the processing result in the state transition management apparatus 100A is a registration error or an update error, a new state is not registered in the state transition management apparatus 100n.

For example, when the processing result in the state transition management apparatus 100A is the registration error or the update error, the state registration unit 114 requires the state transition management apparatus 100B to delete the new state. In the state transition management apparatus 100B, the state registration unit 114 deletes the registration state information of the new state upon receiving the request.

### ***Supplements to Embodiments***

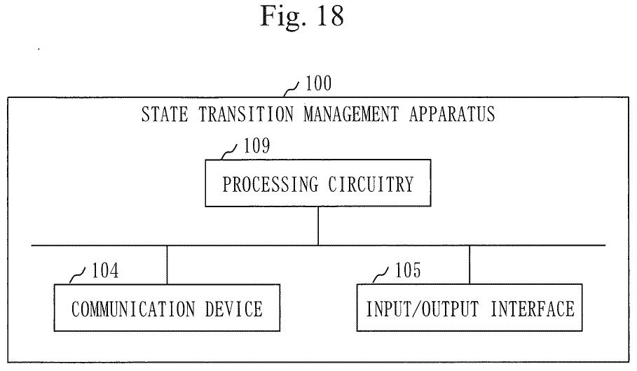

A hardware configuration of the state transition management apparatus 100 will be described based on FIG. 18.

The state transition management apparatus 100 includes processing circuitry 109.

The processing circuitry 109 is hardware that implements the reception unit 111, the rule registration unit 112, the state verification unit 113, the state registration unit 114, and the output unit 115.

The processing circuitry 109 may be dedicated hardware, or may be the processor 101 that executes programs stored in the memory 102.

When the processing circuitry 109 is the dedicated hardware, the processing circuitry 109 is, for example, a single circuit, a compound circuit, a programmed processor, a parallel programmed processor, an ASIC, an FPGA, or a combination thereof.

ASIC is an abbreviation for Application Specific Integrated Circuit.

FPGA is an abbreviation for Field Programmable Gate Array.

The state transition management apparatus 100 may include a plurality of processing circuitry as an alternative to the processing circuitry 109.

In the processing circuitry 109, some functions may be implemented by dedicated hardware, and the remaining functions may be implemented by software or firmware.

In such a manner, the function of the state transition management apparatus 100 can be implemented by hardware, software, firmware or a combination thereof.

Each of the embodiments is an example of a preferred embodiment and is not intended to limit the technical scope of the present disclosure. Each of the embodiments may be implemented partially, or may be implemented in combination with another embodiment. The procedures described using the flowcharts or the like may be modified as appropriate.

“Unit” of each of the elements of the state transition management apparatus 100 may be interpreted as “process”, “step”, “circuit”, or “circuitry”.

### REFERENCE SIGNS LIST

100: state transition management apparatus; 101: processor; 102: memory; 103: auxiliary storage device; 104: communication device; 105: input/output interface; 109: processing circuitry; 111: reception unit; 112: rule registration unit; 113: state verification unit; 114: state registration unit; 115: output unit; 120: storage unit; 121: rule storage unit; 122: state storage unit; 200: state transition management system; 201: rule for registration; 202: rule for updating; 203: registered rule; 204: state registration information; 205: registration state information; 206: state update information; 211: rule transmission device; 212: state transmission device; 213: result display device.

1. A state transition management apparatus comprising:
processing circuitry:
to receive a state transition rule that indicates a series of state transitions, and to receive state registration information that indicates a new state, a rule type, and a version number;
when the received state transition rule is a rule for registration, to set an initial version number for each of one or more state transitions in the series of state transitions, as an event, and to register the set rule for registration to a rule storage unit;
to select from the rule storage unit, a state transition rule whose type is the same as the rule type in the state registration information, and to determine that state registration is possible when a head state of one or more state transitions for which the same version number as the version number in the state registration information is set among states in the selected state transition rule, is consistent with the new state in the state registration information; and
when it is determined that the state registration is possible, to register registration state information that indicates a new registration state identifier and the state registration information to a state storage unit.

2. The state transition management apparatus according to claim 1, wherein
the processing circuitry receives state registration information that indicates a new disclosable state, and
the processing circuitry transmits the received state registration information to a public state transition management apparatus, and when both the public state transition management apparatus and the processing circuitry determine that the state registration is possible, registers the registration state information that indicates the received state registration information to the state storage unit.

3. The state transition management apparatus according to claim 1, wherein
the processing circuitry receives state update information that indicates a registration state identifier, a new state, and a version number,
the processing circuitry selects from the state storage unit, registration state information whose registration state identifier is the same as the registration state identifier in the state update information, selects from the rule storage unit, a state transition rule whose type is the same as the rule type in the selected registration state information, and determines that state update is possible when a state transition from the latest state in the selected registration state information to the new state in the state update information is consistent with any of the state transitions for which the same version number as the version number in the state update information is set among the state transitions in the selected state transition rule, and
the processing circuitry, when it is determined that the state update is possible, updates the selected registration state information based on the state update information.

4. The state transition management apparatus according to claim 3, wherein
the processing circuitry receives state update information that indicates a new disclosable state, and
the processing circuitry transmits the received state update information to the public state transition management apparatus, and when it is determined that the state update is possible in both the public state transition management apparatus and the processing circuitry, updates the registration state information based on the received state update information.

5. A state transition management apparatus comprising:
processing circuitry:
to receive state registration information that indicates a new state, a rule type, and a version number;
to select from a rule storage unit, a state transition rule whose type is the same as the rule type in the state registration information, and to determine that state registration is possible when a head state of one or more state transitions for which the same version number as the version number in the state registration information is set among states in the selected state transition rule, is consistent with the new state in the state registration information; and
when it is determined that the state registration is possible, to register registration state information that indicates a new registration state identifier and the state registration information to a state storage unit.

6. The state transition management apparatus according to claim 5, wherein
the processing circuitry receives state registration information that indicates a new disclosable state, and
the processing circuitry transmits the received state registration information to a public state transition management apparatus, and when both the public state transition management apparatus and the processing circuitry determine that the state registration is possible, registers the registration state information that indicates the received state registration information to the state storage unit.

7. The state transition management apparatus according to claim 5, wherein
the processing circuitry receives state update information that indicates a registration state identifier, a new state, and a version number,
the processing circuitry selects from the state storage unit, registration state information whose registration state identifier is the same as the registration state identifier in the state update information, selects from the rule storage unit, a state transition rule whose type is the same as the rule type in the selected registration state information, and determines that state update is possible when a state transition from the latest state in the selected registration state information to the new state in the state update information is consistent with any of the state transitions for which the same version number as the version number in the state update information is set among the state transitions in the selected state transition rule, and
the processing circuitry, when it is determined that the state update is possible, updates the selected registration state information based on the state update information.

8. The state transition management apparatus according to claim 7, wherein
the processing circuitry receives state update information that indicates a new disclosable state, and
the processing circuitry transmits the received state update information to the public state transition management apparatus, and when it is determined that the state update is possible in both the public state transition management apparatus and the processing circuitry, updates the registration state information based on the received state update information.

9. A state transition management method comprising:
receiving a state transition rule that indicates a series of state transitions;
when the received state transition rule is a rule for registration, setting an initial version number for each of one or more state transitions in the series of state transitions, as an event, and registering the set rule for registration to a rule storage unit;
receiving state registration information that indicates a new state, a rule type, and a version number;
selecting from the rule storage unit, a state transition rule whose type is the same as the rule type in the state registration information, and determining that state registration is possible when a head state of one or more state transitions for which the same version number as the version number in the state registration information is set among states in the selected state transition rule, is consistent with the new state in the state registration information; and
when it is determined that the state registration is possible, registering registration state information that indicates a new registration state identifier and the state registration information to a state storage unit.

10. A state transition management method comprising:
receiving state registration information that indicates a new state, a rule type, and a version number;
selecting from a rule storage unit, a state transition rule whose type is the same as the rule type in the state registration information, and determining that state registration is possible when a head state of one or more state transitions for which the same version number as the version number in the state registration information is set among states in the selected state transition rule, is consistent with the new state in the state registration information; and
when it is determined that the state registration is possible, registering registration state information that indicates a new registration state identifier and the state registration information to a state storage unit.

11. A non-transitory computer readable medium storing a state transition management program for causing a computer to execute:
a reception process to receive a state transition rule that indicates a series of state transitions, and to receive state registration information that indicates a new state, a rule type, and a version number;
a rule registration process, when the received state transition rule is a rule for registration, to set an initial version number for each of one or more state transitions in the series of state transitions, as an event, and to register the set rule for registration to a rule storage unit;
a state verification process to select from the rule storage unit, a state transition rule whose type is the same as the rule type in the state registration information, and to determine that state registration is possible when a head state of one or more state transitions for which the same version number as the version number in the state registration information is set among states in the selected state transition rule, is consistent with the new state in the state registration information; and
a state registration process, when it is determined that the state registration is possible, to register registration state information that indicates a new registration state identifier and the state registration information to a state storage unit.

12. A non-transitory computer readable medium storing a state transition management program for causing a computer to execute:
a reception process to receive state registration information that indicates a new state, a rule type, and a version number;
a state verification process to select from a rule storage unit, a state transition rule whose type is the same as the rule type in the state registration information, and to determine that state registration is possible when a head state of one or more state transitions for which the same version number as the version number in the state registration information is set among states in the selected state transition rule, is consistent with the new state in the state registration information; and
a state registration process, when it is determined that the state registration is possible, to register registration state information that indicates a new registration state identifier and the state registration information to a state storage unit.

13. The state transition management apparatus according to claim 2, wherein
the processing circuitry receives state update information that indicates a registration state identifier, a new state, and a version number,
the processing circuitry selects from the state storage unit, registration state information whose registration state identifier is the same as the registration state identifier in the state update information, selects from the rule storage unit, a state transition rule whose type is the same as the rule type in the selected registration state information, and determines that state update is possible when a state transition from the latest state in the selected registration state information to the new state in the state update information is consistent with any of the state transitions for which the same version number as the version number in the state update information is set among the state transitions in the selected state transition rule, and
the processing circuitry, when it is determined that the state update is possible, updates the selected registration state information based on the state update information.

14. The state transition management apparatus according to claim 13, wherein
the processing circuitry receives state update information that indicates a new disclosable state, and
the processing circuitry transmits the received state update information to the public state transition management apparatus, and when it is determined that the state update is possible in both the public state transition management apparatus and the processing circuitry, updates the registration state information based on the received state update information.

15. The state transition management apparatus according to claim 6, wherein
the processing circuitry receives state update information that indicates a registration state identifier, a new state, and a version number,
the processing circuitry selects from the state storage unit, registration state information whose registration state identifier is the same as the registration state identifier in the state update information, selects from the rule storage unit, a state transition rule whose type is the same as the rule type in the selected registration state information, and determines that state update is possible when a state transition from the latest state in the selected registration state information to the new state in the state update information is consistent with any of the state transitions for which the same version number as the version number in the state update information is set among the state transitions in the selected state transition rule, and
the processing circuitry, when it is determined that the state update is possible, updates the selected registration state information based on the state update information.

16. The state transition management apparatus according to claim 15, wherein
the processing circuitry receives state update information that indicates a new disclosable state, and
the processing circuitry transmits the received state update information to the public state transition management apparatus, and when it is determined that the state update is possible in both the public state transition management apparatus and the processing circuitry, updates the registration state information based on the received state update information.
